(19) United States
(12) Patent Application Publication
(10) Pub. No.: US 2025/0011136 A1
(43) Pub. Date: Jan. 9, 2025

(54) DIE LIFTING LUG STRUCTURE

(71) Applicants: Hyundai Motor Company, Seoul (KR); Kia Corporation, Seoul (KR)

(72) Inventor: Ae Sol Song, Ulsan (KR)

(21) Appl. No.: 18/496,003

(22) Filed: Oct. 27, 2023

(30) Foreign Application Priority Data
Jul. 7, 2023 (KR) 10-2023-0088444

(51) Int. Cl. B66C 1/22; B21C 25/02

(52) U.S. Cl. CPC B66C 1/22; B21C 25/02

(57) ABSTRACT

An embodiment die lifting lug structure includes a pair of lugs protruding from a die and spaced apart from each other and a lifting pin detachably mounted on the pair of lugs, wherein the lifting pin includes a body having a first end surface and a second end surface, a fixed ring fixed to the body, and a stopper ring configured to be movable between the body and the fixed ring in a radial direction of the body, wherein each lug of the pair of lugs includes a through hole configured to allow the body, the fixed ring, and the stopper ring of the lifting pin to pass therethrough.

### CROSS-REFERENCE TO RELATED APPLICATIONS

This application claims the benefit of Korean Patent Application No. 10-2023-0088444, filed on Jul. 7, 2023, which application is hereby incorporated herein by reference.

### TECHNICAL FIELD

The present disclosure relates to a die lifting lug structure.

### BACKGROUND

A die may have a lug attached adjacent to each edge thereof, and a lifting pin may be detachably mounted on the lug. An end portion of a cable or wire may be connected to the lifting pin. A crane or hoist may be connected to the wire, and the die may be moved up and down or be reversed by the movement of the crane or hoist. The weight of the die may be relatively heavy (e.g., 10-30 tons), and a load may be concentrated on the lifting pin when the die is moved up and down or is reversed, so the lifting pin is considered an important component to ensure safety during the movement of the die.

The lifting pin may be classified into a ring-type lifting pin having a stopper ring and a fixed ring provided at one end portion of a body and a stopper-type lifting pin having a stopper and a stopper groove.

When the die is reversed, the ring-type lifting pin according to the related art may be arbitrarily released from the lug, so the falling of the die may occur. In addition, when the related art ring-type lifting pin is manually released from the lug by a worker, the worker's safety accident(s) may frequently occur.

The stopper-type lifting pin according to the related art may cause the wire to be damaged due to the stopper groove. When the die is reversed, the load may be concentrated between the die and a grip of the lifting pin so that the grip may be easily damaged.

In addition, the related art lifting pin may be arbitrarily released from the lug due to vibration acting on the die in a state in which the lifting pin is mounted on the lug.

The above information described in this background section is provided to assist in understanding the background of the inventive concept and may include any technical concept which is not considered as the prior art that is already known to those skilled in the art.

### SUMMARY

The present disclosure relates to a die lifting lug structure. Particular embodiments relate to a die lifting lug structure designed to allow a lifting pin to be detachably mounted on a lug of a die with ease and safety.

Embodiments of the present disclosure can solve problems occurring in the prior art while advantages achieved by the prior art are maintained intact.

An embodiment of the present disclosure provides a die lifting lug structure designed to allow a lifting pin to be detachably mounted on a lug of a die with ease and safety, thereby improving work safety and ease of use.

According to an embodiment of the present disclosure, a die lifting lug structure may include a pair of lugs protruding from a die, and spaced apart from each other, and a lifting pin detachably mounted on the pair of lugs. The lifting pin may include a body having a first end surface and a second end surface, a fixed ring fixed to the body, and a stopper ring configured to be movable between the body and the fixed ring in a radial direction of the body. Each lug may have a through hole allowing the body, the fixed ring, and the stopper ring of the lifting pin to pass therethrough.

An outer diameter of the body may be substantially the same as an inner diameter of the through hole, and an outer diameter of the fixed ring and an outer diameter of the stopper ring may be substantially the same as the outer diameter of the body.

The body may include a support projection protruding from the first end surface and a fixed projection protruding from the support projection. The stopper ring may be elastically supported to the support projection by a spiral spring.

A central longitudinal axis of the support projection may be aligned with a central longitudinal axis of the fixed projection, and the central longitudinal axis of the support projection may be aligned with a central longitudinal axis of the fixed ring and a central longitudinal axis of the body.

A central longitudinal axis of the stopper ring may be eccentrically biased from a central longitudinal axis of the body by a spring force of the spiral spring.

The central longitudinal axis of the stopper ring may be aligned with the central longitudinal axis of the body when an external force greater than the spring force of the spiral spring acts radially inward on the stopper ring.

The spiral spring may include an inner winding wound around an outer surface of the support projection and an outer winding at least partially contacting an inner surface of the stopper ring. A center of curvature of the inner winding may be aligned with a center of the support projection, and a center of curvature of the outer winding may be spaced apart from the center of the support projection.

The support projection may have a predetermined knurl pattern provided on an outer surface thereof, and the inner winding of the spiral spring may frictionally contact the knurl pattern of the support projection.

The spiral spring may have a tip bent from an inner end thereof, and the support projection may have a recess receiving the tip.

The die lifting lug structure may further include a grip fixed to the second end surface of the body.

The grip may have a stopper surface protruding outward from the second end surface of the body.

The die lifting lug structure may further include a pressing block protruding from an outer surface of at least one of the pair of lugs. The pressing block may have a pressing surface which is allowed to come into contact with the stopper ring.

A radius of the pressing surface may be substantially the same as that of the stopper ring.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 illustrates a perspective view of a die lifting lug structure according to an exemplary embodiment of the present disclosure;

FIG. 2 illustrates a lifting pin of a die lifting lug structure according to an exemplary embodiment of the present disclosure;

FIG. 3 illustrates a lifting pin of a die lifting lug structure according to an exemplary embodiment of the present disclosure, from which a fixed ring and a stopper ring are removed;

FIG. 4 illustrates a spiral spring of a die lifting lug structure according to an exemplary embodiment of the present disclosure;

FIG. 5 illustrates a cross-sectional view taken along line A-A of FIG. 2;

FIG. 6 illustrates a modification to the exemplary embodiment illustrated in FIG. 5;

FIG. 7 illustrates a stopper ring of a die lifting lug structure according to an exemplary embodiment of the present disclosure;

FIG. 8 illustrates a fixed ring of a die lifting lug structure according to an exemplary embodiment of the present disclosure;

FIG. 9 illustrates a state in which a stopper ring of a lifting pin is locked to a first lug in a die lifting lug structure according to an exemplary embodiment of the present disclosure as the stopper ring of the lifting pin is eccentrically biased upward from a body and a fixed ring of the lifting pin;

FIG. 10 illustrates a state in which a stopper ring of a lifting pin is locked to a first lug in a die lifting lug structure according to an exemplary embodiment of the present disclosure as the stopper ring of the lifting pin is eccentrically biased downward from a body and a fixed ring of the lifting pin; and

FIG. 11 illustrates a state in which a stopper ring of a lifting pin is aligned with a body and a fixed ring of the lifting pin in a die lifting lug structure according to an exemplary embodiment of the present disclosure as the stopper ring of the lifting pin comes into contact with a pressing surface of a pressing block of a first lug.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

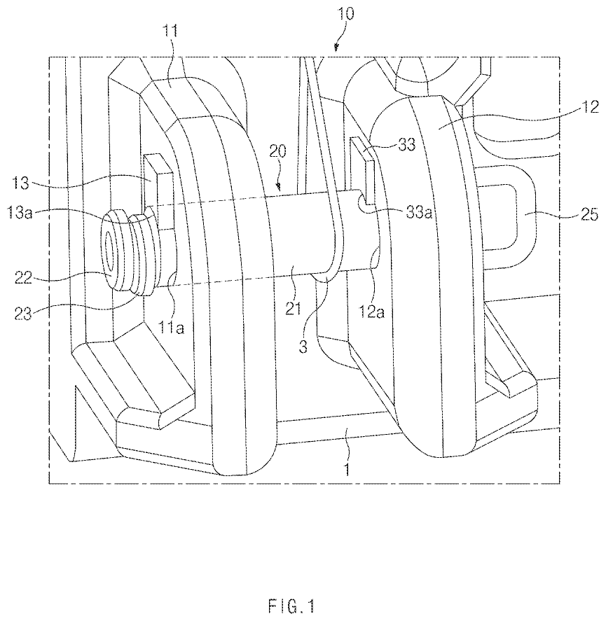

Referring to FIG. 1, a die lifting lug structure 10 according to an exemplary embodiment of the present disclosure may include a pair of lugs 11 and 12 protruding from a die 1 and a lifting pin 20 detachably mounted on the pair of lugs 11 and 12.

Referring to FIG. 1, the pair of lugs 11 and 12 may include a first lug 11 and a second lug 12 spaced apart from the first lug 11. The first lug 11 may have a first through hole 11a, and the second lug 12 may have a second through hole 12a. The second through hole 12a of the second lug 12 may be aligned with the first through hole 11a of the first lug 11. A diameter of the first through hole 11a may be the same as a diameter of the second through hole 12a, and a central longitudinal axis of the first through hole 11a may be aligned with a central longitudinal axis of the second through hole 12a.

The lifting pin 20 may be inserted into the first through hole 11a of the first lug 11 and the second through hole 12a of the second lug 12 so that a middle portion of the lifting pin 20 may be exposed through a gap between the first lug 11 and the second lug 12, and a cable or wire 3 may be wound around the middle portion of the lifting pin 20.

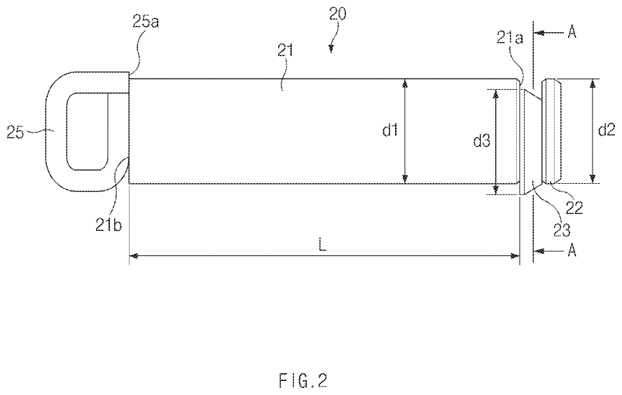

Referring to FIG. 2, the lifting pin 20 may include a body 21, a fixed ring 22 fixed to the body 21, and a stopper ring 23 configured to be movable between the body 21 and the fixed ring 22 in a radial direction of the body 21.

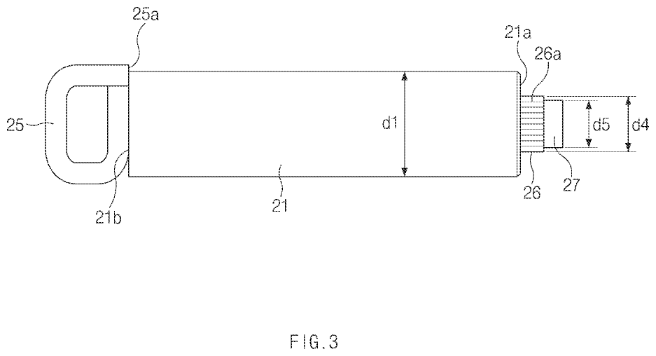

The body 21 may have a cylindrical shape with a predetermined length Land a predetermined outer diameter d1, and the outer diameter d1 of the body 21 may be substantially the same as an inner diameter of the first through hole 11a and an inner diameter of the second through hole 12a. Referring to FIG. 3, the body 21 may have a first end surface 21a and a second end surface 21b opposing each other. The body 21 may have a support projection 26 protruding from the first end surface 21a of the body 21 to a predetermined length, and a central longitudinal axis of the support projection 26 may be aligned with a central longitudinal axis X1 of the body 21. The body 21 may have a fixed projection 27 protruding from the support projection 26 to a predetermined length, and a central longitudinal axis of the fixed projection 27 may be aligned with the central longitudinal axis of the support projection 26 and the central longitudinal axis X1 of the body 21. An outer diameter d5 of the fixed projection 27 may be less than an outer diameter d4 of the support projection 26.

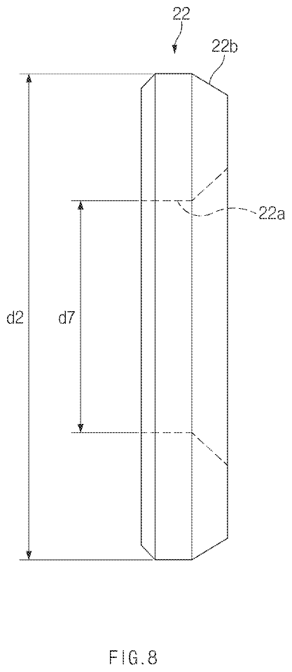

The fixed ring 22 may be fixed to the fixed projection 27. The central longitudinal axis of the fixed projection 27 may be aligned with a central longitudinal axis X2 of the fixed ring 22, and the central longitudinal axis X2 of the fixed ring 22 may be aligned with the central longitudinal axis X1 of the body 21. Referring to FIG. 8, the fixed ring 22 may have a predetermined outer diameter d2 and a predetermined inner diameter d7. The outer diameter d2 of the fixed ring 22 may be substantially the same as the outer diameter d1 of the body 21, and the inner diameter d7 of the fixed ring 22 may be the same as the outer diameter d5 of the fixed projection 27. According to an exemplary embodiment, an inner surface of the fixed ring 22 may be fixed to an outer surface of the fixed projection 27 by CO₂ welding so that welding strength between the fixed ring 22 and the fixed projection 27 may be increased. In addition, the fixed ring 22 may have a tapered surface 22b provided on an outer surface thereof. When the lifting pin 20 is inserted into the second through hole 12a of the second lug 12 and the first through hole 11a of the first lug 11, the tapered surface 22b may allow the fixed ring 22 to be smoothly inserted into the second through hole 12a of the second lug 12 and the first through hole 11a of the first lug 11.

The stopper ring 23 may be elastically supported to the support projection 26 of the body 21 through a spiral spring 24, and a central longitudinal axis X3 of the stopper ring 23 may be eccentrically biased from the central longitudinal axis X1 of the body 21 and the central longitudinal axis X2 of the fixed ring 22 by a spring force of the spiral spring 24. When an external force greater than the spring force of the spiral spring 24 acts radially inward on the stopper ring 23, the central longitudinal axis X3 of the stopper ring 23 may be aligned with the central longitudinal axis X1 of the body 21 and the central longitudinal axis X2 of the fixed ring 22.

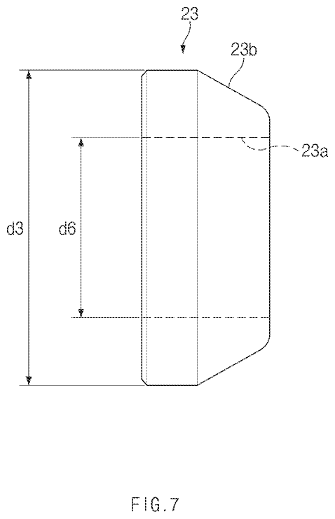

Referring to FIG. 7, the stopper ring 23 may have a predetermined outer diameter d3 and a predetermined inner diameter d6. The outer diameter d3 of the stopper ring 23 may be substantially the same as the outer diameter d1 of the body 21, and the inner diameter d6 of the stopper ring 23 may be greater than the outer diameter d4 of the support projection 26. In addition, the stopper ring 23 may have a tapered surface 23b provided on an outer surface thereof. When the lifting pin 20 is inserted into the second through hole 12a of the second lug 12 and the first through hole 11a of the first lug 11, the tapered surface 23b may allow the stopper ring 23 to be smoothly inserted into the second through hole 12a of the second lug 12 and the first through hole 11a of the first lug 11.

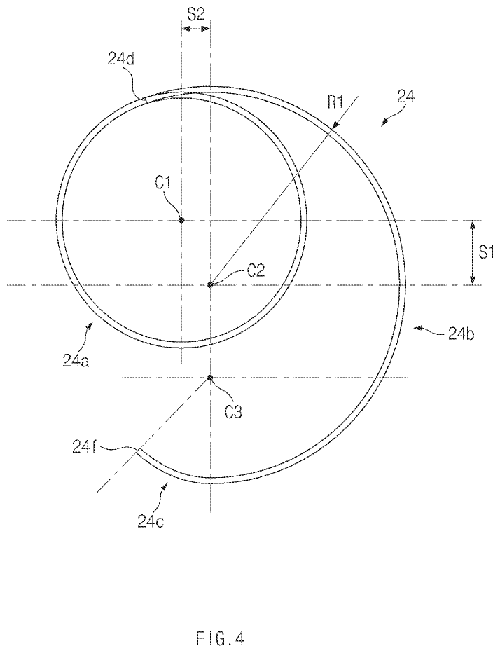

Referring to FIG. 4, the spiral spring 24 may have an inner end 24d and an outer end 24f. The spiral spring 24 may include an inner winding 24a and an outer winding 24b continuously connected to the inner winding 24a. A center of curvature C2 of the outer winding 24b may be spaced apart from a center of curvature C1 of the inner winding 24a by a predetermined vertical distance S1 and a predetermined horizontal distance S2. In addition, the spiral spring 24 may include a curved portion 24c which is curved from the outer winding 24b. A center of curvature C3 of the curved portion 24c may be spaced apart from the center of curvature C2 of the outer winding 24b. A radius of curvature of the outer winding 24b may be slightly greater than or be equal to that of the stopper ring 23.

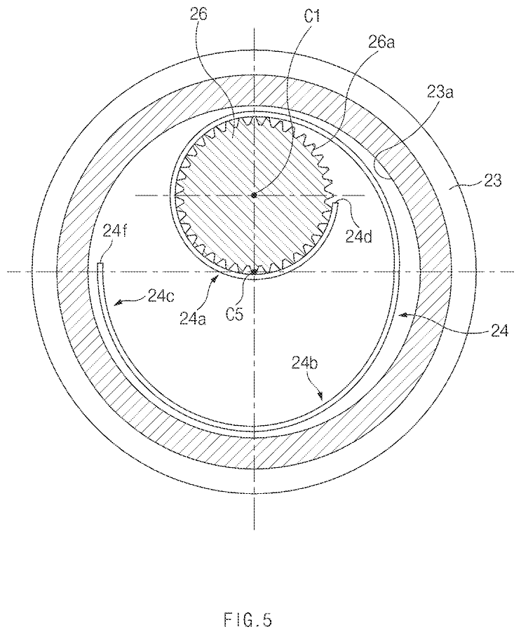

Referring to FIG. 5, the inner winding 24a of the spiral spring 24 may be wound around the outer surface of the support projection 26 of the body 21, and the outer winding 24b of the spiral spring 24 may at least partially contact an inner surface 23a of the stopper ring 23. The center of curvature C1 of the inner winding 24a may be aligned with the center of the support projection 26, and the center C5 of the stopper ring 23 may be spaced apart from the center of the support projection 26. Accordingly, the center C5 of the stopper ring 23 may be eccentrically biased from the center of the body 21 by the spiral spring 24.

As the external force overcoming the spring force of the spiral spring 24 is applied radially inward to the stopper ring 23, the outer winding 24b of the spiral spring 24 may be contracted toward the center of the support projection 26, and accordingly the center C5 of the stopper ring 23 may be aligned with the center of the support projection 26. Thus, the central longitudinal axis X3 of the stopper ring 23 may be forcibly aligned with the central longitudinal axis X1 of the body 21 and the central longitudinal axis X2 of the fixed ring 22 by the external force. When the lifting pin 20 sequentially passes through the second through hole 12a of the second lug 12 and the first through hole 11a of the first lug 11, the stopper ring 23 may come into contact with an inner surface of the second through hole 12a of the second lug 12, an inner surface of the first through hole 11a of the first lug 11, and a pressing surface 13a of a pressing block 13 so that the outer winding 24b of the spiral spring 24 may be contracted toward the center of the support projection 26. Accordingly, the center C5 of the stopper ring 23 may be aligned with the center of the support projection 26 so that the central longitudinal axis X3 of the stopper ring 23 may be aligned with the central longitudinal axis X1 of the body 21 and the central longitudinal axis X2 of the fixed ring 22.

Referring to FIGS. 3 and 5, the support projection 26 may have a predetermined knurl pattern formed on the outer surface thereof. The inner surface and/or inner end 24d of the spiral spring 24 may frictionally contact the knurl pattern so that the inner surface and/or inner end 24d of the spiral spring 24 may be prevented from slipping on the outer surface of the support projection 26 in a rotational direction. Accordingly, the spiral spring 24 may be prevented from slipping in the rotational direction between the outer surface of the support projection 26 and the inner surface 23a of the stopper ring 23.

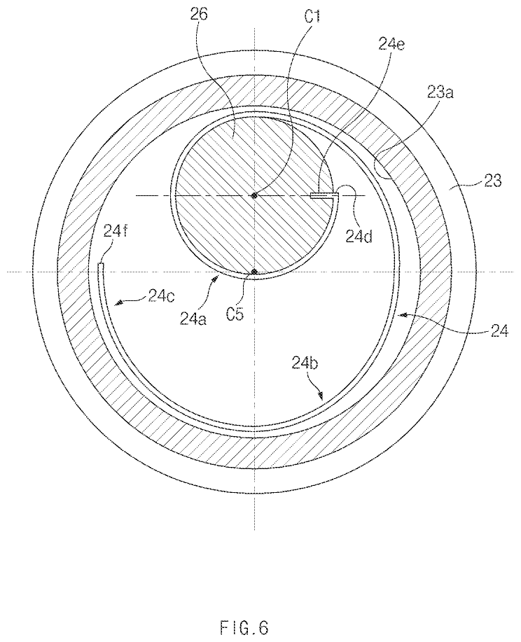

According to an alternative exemplary embodiment, the spiral spring 24 may have a tip 24e bent from the inner end 24d as illustrated in FIG. 6, and the support projection 26 may have a recess in which the tip 24e of the spiral spring 24 is received. As the tip 24e of the spiral spring 24 is inserted into the recess of the support projection 26, the inner winding 24a of the spiral spring 24 may be fixed to the support projection 26, and accordingly the spiral spring 24 may be prevented from slipping in the rotational direction between the outer surface of the support projection 26 and the inner surface 23a of the stopper ring 23.

The lifting pin 20 may be inserted into the second through hole 12a of the second lug 12 and the first through hole 11a of the first lug 11 so that the lifting pin 20 may be mounted on the second lug 12 and the first lug 11. In a state in which the lifting pin 20 is mounted on the second lug 12 and the first lug 11, the second end surface 21b of the body 21 may be exposed from the second through hole 12a of the second lug 12, and the first end surface 21a of the body 21 may be exposed from the first through hole 11a of the first lug 11.

Referring to FIGS. 2 and 3, the lifting pin 20 may have a grip 25 fixed to the second end surface 21b of the body 21, and the grip 25 may be fixed to the second end surface 21b of the body 21 by CO₂ welding and/or the like. The grip 25 may have a stopper surface 25a protruding outward from the second end surface 21b of the body 21. When the lifting pin 20 is inserted into the second through hole 12a of the second lug 12, the stopper surface 25a may be stopped against the second lug 12 so that the grip 25 may be prevented from being inserted into the second through hole 12a of the second lug 12.

Referring to FIGS. 1, 9, 10, and 11, the first lug 11 may have the pressing block 13, and the pressing block 13 may protrude from an outer surface of the first lug 11. According to an exemplary embodiment, the pressing block 13 and the first lug 11 may form a unitary one-piece structure. According to another exemplary embodiment, the pressing block 13 may be provided separately from the first lug 11, and the pressing block 13 may be fixed to the outer surface of the first lug 11 using fasteners, welding, and/or the like.

The pressing block 13 may be disposed toward the center of the first through hole 11a of the first lug 11 and may be positioned to match a portion of an outer circumferential surface of the first through hole 11a of the first lug 11. For example, the pressing block 13 may be positioned on an upper portion of the outer circumferential surface of the first through hole 11a of the first lug 11.

The pressing block 13 may have the pressing surface 13a matching the portion of the outer circumferential surface of the stopper ring 23. When the lifting pin 20 rotates and moves, the portion of the outer circumferential surface of the stopper ring 23 of the lifting pin 20 may come into contact with the pressing surface 13a so that the stopper ring 23 may be pressed toward the center of the body 21 of the lifting pin 20 by the pressing surface 13a. A radius of the pressing surface 13a may be the same as a radius of the first through hole 11a and a radius of the stopper ring 23, or it may be slightly greater than the radius of the first through hole 11a and the radius of the stopper ring 23. That is, the radius of the pressing surface 13a may be substantially the same as the radius of the first through hole 11a and the radius of the stopper ring 23.

As a worker holds the grip 25 and pushes the lifting pin 20 into the second through hole 12a of the second lug 12 and the first through hole 11a of the first lug 11 in a locking direction, the lifting pin 20 may be inserted into the second through hole 12a of the second lug 12 and the first through hole 11a of the first lug 11. In particular, when the worker pushes the lifting pin 20 into the second through hole 12a of the second lug 12 and the first through hole 11a of the first lug 11, the worker may rotate the lifting pin 20 around the central longitudinal axis X1 of the body 21 so that the lifting pin 20 may be more easily inserted into the second through hole 12a of the second lug 12 and the first through hole 11a of the first lug 11.

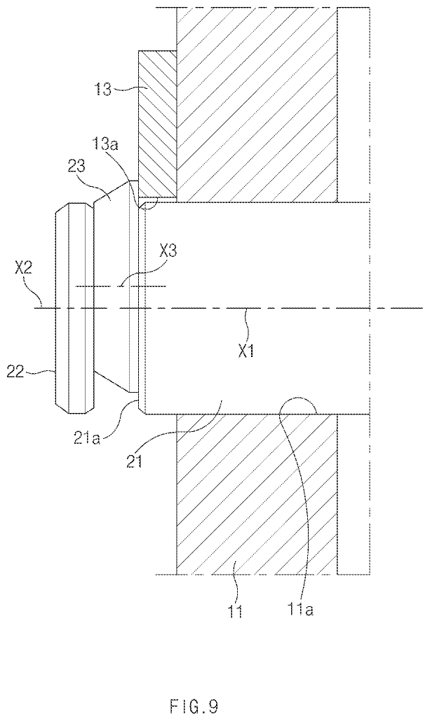

FIG. 9 illustrates a state in which the stopper ring 23 of the lifting pin 20 is locked to the first lug 11 as the stopper ring 23 of the lifting pin 20 is eccentrically biased upward from the body 21 and the fixed ring 22.

When the lifting pin 20 is fully inserted into the second through hole 12a of the second lug 12 and the first through hole 11a of the first lug 11, the first end surface 21a of the body 21 of the lifting pin 20 may be fully exposed from the first through hole 11a of the first lug 11, and the second end surface 21b of the body 21 of the lifting pin 20 may be exposed from the second through hole 12a of the second lug 12. Referring to FIG. 9, the first end surface 21a of the body 21 may be fully exposed from the first through hole 11a of the first lug 11 so that the central longitudinal axis X3 of the stopper ring 23 may be eccentrically biased upward from the central longitudinal axis X1 of the body 21 and the central longitudinal axis X2 of the fixed ring 22. Accordingly, the stopper ring 23 of the lifting pin 20 may be locked to the pressing block 13 of the first lug 11, and the lifting pin 20 may be firmly fixed to the second lug 12 and the first lug 11.

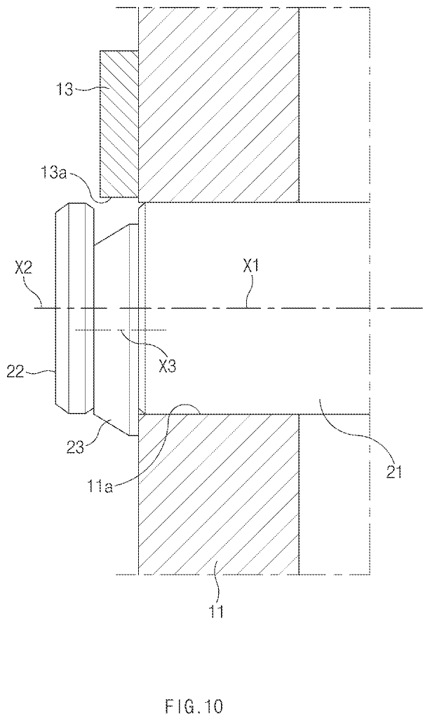

FIG. 10 illustrates a state in which the stopper ring 23 of the lifting pin 20 is locked to the first lug 11 as the stopper ring 23 of the lifting pin 20 is eccentrically biased downward from the body 21 and the fixed ring 22.

Referring to FIG. 10, in a state in which the first end surface 21a of the body 21 of the lifting pin 20 is exposed from the first through hole 11a of the first lug 11, when the body 21 of the lifting pin 20 rotates around the central longitudinal axis X1 thereof at a predetermined angle, the central longitudinal axis X3 of the stopper ring 23 may be eccentrically biased downward from the central longitudinal axis X1 of the body 21 and the central longitudinal axis X2 of the fixed ring 22. Accordingly, the stopper ring 23 of the lifting pin 20 may be locked to the outer surface of the first lug 11 so that the lifting pin 20 may be firmly fixed to the second lug 12 and the first lug 11.

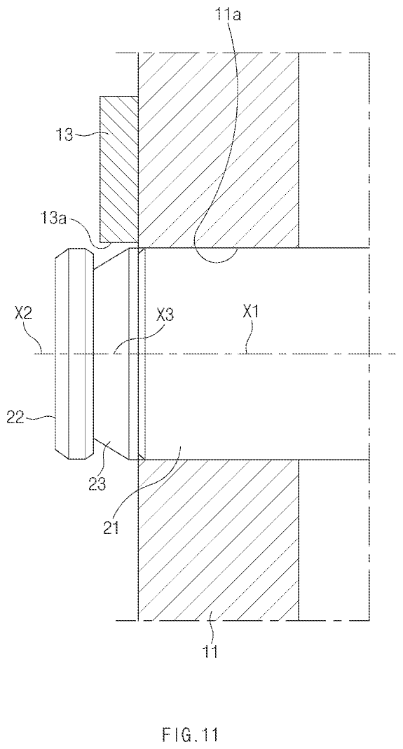

FIG. 11 illustrates a state in which the stopper ring 23 of the lifting pin 20 is aligned with the body 21 and the fixed ring 22 as the stopper ring 23 of the lifting pin 20 comes into contact with the pressing surface 13a of the pressing block 13 of the first lug 11.

Referring to FIG. 11, in a state in which the first end surface 21a of the body 21 of the lifting pin 20 is fully exposed from the first through hole 11a of the first lug 11, when the body 21 of the lifting pin 20 rotates around the central longitudinal axis X1 thereof at a predetermined angle, the stopper ring 23 of the lifting pin 20 may come into contact with the pressing surface 13a of the pressing block 13, and the stopper ring 23 may be pressed toward the center of the support projection 26 by the pressing surface 13a of the pressing block 13 so that the central longitudinal axis X3 of the stopper ring 23 may be aligned with the central longitudinal axis X1 of the body 21 and the central longitudinal axis X2 of the fixed ring 22. Accordingly, the stopper ring 23 and the fixed ring 22 of the body 21 of the lifting pin 20 may be easily released from the first through hole 11a of the first lug 11. As the pressing block 13 of the first lug 11 presses the stopper ring 23, the stopper ring 23 may be aligned with the body 21 and the fixed ring 22. In this state, as the worker pulls the lifting pin 20 in a release direction, the lifting pin 20 may be completely released from the first lug 11.

As set forth above, according to exemplary embodiments of the present disclosure, as the stopper ring of the lifting pin is eccentrically biased from the body and the fixed ring by the spiral spring, the locking of the lifting pin and the lug may be stably maintained, and the lifting pin may be prevented from being released from the lug due to the external force.

According to exemplary embodiments of the present disclosure, as the stopper ring of the lifting pin is pressed by the pressing block provided on the lug, the lifting pin may be aligned with the body and the fixed ring, and accordingly the lifting pin may be easily released from the lug.

Hereinabove, although embodiments of the present disclosure have been described with reference to exemplary embodiments and the accompanying drawings, the embodiments of the present disclosure are not limited thereto, but they may be variously modified and altered by those skilled in the art to which the present disclosure pertains without departing from the spirit and scope of the present disclosure claimed in the following claims.

What is claimed is:

1. A die lifting lug structure, comprising:
a pair of lugs protruding from a die and spaced apart from each other; and
a lifting pin detachably mounted on the pair of lugs, wherein the lifting pin comprises:
a body having a first end surface and a second end surface;
a fixed ring fixed to the body; and
a stopper ring configured to be movable between the body and the fixed ring in a radial direction of the body, wherein each lug of the pair of lugs comprises a through hole configured to allow the body, the fixed ring, and the stopper ring of the lifting pin to pass therethrough.

2. The structure according to claim 1, wherein:
an outer diameter of the body is substantially equal to an inner diameter of the through hole; and
an outer diameter of the fixed ring and an outer diameter of the stopper ring are substantially equal to the outer diameter of the body.

3. The structure according to claim 1, wherein:
the body comprises a support projection protruding from the first end surface and a fixed projection protruding from the support projection; and
the stopper ring is elastically supported to the support projection by a spiral spring.

4. The structure according to claim 3, wherein:
a central longitudinal axis of the support projection is aligned with a central longitudinal axis of the fixed projection; and
the central longitudinal axis of the fixed projection is aligned with a central longitudinal axis of the fixed ring and a central longitudinal axis of the body.

5. The structure according to claim 3, wherein a central longitudinal axis of the stopper ring is eccentrically biased from a central longitudinal axis of the body by a spring force of the spiral spring.

6. The structure according to claim 5, wherein the central longitudinal axis of the stopper ring is aligned with the central longitudinal axis of the body in a state in which an external force greater than the spring force of the spiral spring acts radially inward on the stopper ring.

7. The structure according to claim 3, wherein:
the spiral spring comprises an inner winding wound around an outer surface of the support projection and an outer winding at least partially contacting an inner surface of the stopper ring;
a center of curvature of the inner winding is aligned with a center of the support projection; and
a center of curvature of the outer winding is spaced apart from the center of the support projection.

8. The structure according to claim 7, wherein:
the support projection comprises a predetermined knurl pattern on an outer surface thereof; and
the inner winding of the spiral spring is configured to frictionally contact the knurl pattern of the support projection.

9. The structure according to claim 3, wherein:
the spiral spring comprises a tip bent from an inner end thereof; and
the support projection comprises a recess configured to receive the tip.

10. A die lifting lug structure, the structure comprising:
a pair of lugs protruding from a die and spaced apart from each other; and
a lifting pin detachably mounted on the pair of lugs, wherein the lifting pin comprises:
a body having a first end surface and a second end surface;
a grip fixed to the second end surface of the body;
a fixed ring fixed to the body; and
a stopper ring configured to be movable between the body and the fixed ring in a radial direction of the body, wherein each lug of the pair of lugs comprises a through hole configured to allow the body, the fixed ring, and the stopper ring of the lifting pin to pass therethrough.

11. The structure according to claim 10, wherein the grip comprises a stopper surface protruding outward from the second end surface of the body.

12. The structure according to claim 10, wherein:
an outer diameter of the body is substantially equal to an inner diameter of the through hole; and
an outer diameter of the fixed ring and an outer diameter of the stopper ring are substantially equal to the outer diameter of the body.

13. The structure according to claim 10, wherein:
the body comprises a support projection protruding from the first end surface and a fixed projection protruding from the support projection; and
the stopper ring is elastically supported to the support projection by a spiral spring.

14. A die lifting lug structure, the structure comprising:
a pair of lugs protruding from a die and spaced apart from each other;
a lifting pin detachably mounted on the pair of lugs, wherein the lifting pin comprises:
a body having a first end surface and a second end surface;
a fixed ring fixed to the body; and
a stopper ring configured to be movable between the body and the fixed ring in a radial direction of the body, wherein each lug of the pair of lugs comprises a through hole configured to allow the body, the fixed ring, and the stopper ring of the lifting pin to pass therethrough; and
a pressing block protruding from an outer surface of one lug of the pair of lugs, wherein the pressing block comprises a pressing surface configured to come into contact with the stopper ring.

15. The structure according to claim 14, wherein a radius of the pressing surface is substantially equal to a radius of the stopper ring.

16. The structure according to claim 14, wherein:
an outer diameter of the body is substantially equal to an inner diameter of the through hole; and
an outer diameter of the fixed ring and an outer diameter of the stopper ring are substantially equal to the outer diameter of the body.

17. The structure according to claim 14, wherein:
the body comprises a support projection protruding from the first end surface and a fixed projection protruding from the support projection; and
the stopper ring is elastically supported to the support projection by a spiral spring.

18. The structure according to claim 17, wherein:
the spiral spring comprises an inner winding wound around an outer surface of the support projection and an outer winding at least partially contacting an inner surface of the stopper ring;
a center of curvature of the inner winding is aligned with a center of the support projection; and
a center of curvature of the outer winding is spaced apart from the center of the support projection.

19. The structure according to claim 18, wherein:
the support projection comprises a predetermined knurl pattern on an outer surface thereof; and
the inner winding of the spiral spring is configured to frictionally contact the knurl pattern of the support projection.

20. The structure according to claim 17, wherein:
the spiral spring comprises a tip bent from an inner end thereof; and
the support projection comprises a recess configured to receive the tip.
